(19) United States
(12) Patent Application Publication
(10) Pub. No.: US 2010/0238621 A1
(43) Pub. Date: Sep. 23, 2010

(54) INSERT-MOLDED CONDUCTOR

(76) Inventors: Mark S. Tracy, Tomball, TX (US); Paul J. Doczy, Cypress, TX (US); Dustin L. Hoffman, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/407,943

(22) Filed: Mar. 20, 2009

(51) Int. Cl. G06F 1/16; B29C 45/14

(52) U.S. Cl. 361/679.27; 264/272.11

(57) ABSTRACT

A display housing includes an injection-molded enclosure, configured for attachment to a base of a portable computer at a hinge region, and a conductor, insert-molded into the enclosure, extending from the hinge region.

### BACKGROUND

Many notebook PCs are configured with built-in antennas for wireless communications. It has been found that placing an antenna in the top of an LCD display enclosure of a notebook computer helps improve reception. These enclosures typically also include many other components, including cables for speakers, microphones, keyboard lights and cameras. Some notebook PCs can have more than ten different cables that are routed through the display enclosure. Assembly and cable routing for these devices can be difficult and time consuming, leading to increased manufacturing expense and more avenues for manufacturing defects.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a perspective view of an embodiment of a notebook computer having an antenna and its associated cable encased within the display enclosure;

FIG. 2 is a front view of the display enclosure of the notebook computer of FIG. 1 with the LCD display and associated components removed to show the antenna cable and antenna;

FIG. 3 is a cross-sectional view of the display enclosure of FIG. 2; and

FIG. 4 is a partially broken-out, perspective view of a portion of the display enclosure of FIG. 2.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

As used herein, directional terms, such as “top,” “bottom,” “front,” “back,” “leading,” “trailing,” etc, are used with reference to the orientation of the figures being described. Because components of various embodiments disclosed herein can be positioned in a number of different orientations, the directional terminology is used for illustrative purposes only, and is not intended to be limiting.

As noted above, many notebook PCs are configured with built-in antennas that are placed in the top of the LCD display enclosure for improved reception. However, these enclosures can include many other cables, such as for speakers, microphones, keyboard lights, cameras, etc. Assembly and cable routing for these devices can be difficult and time-consuming, leading to increased expense.

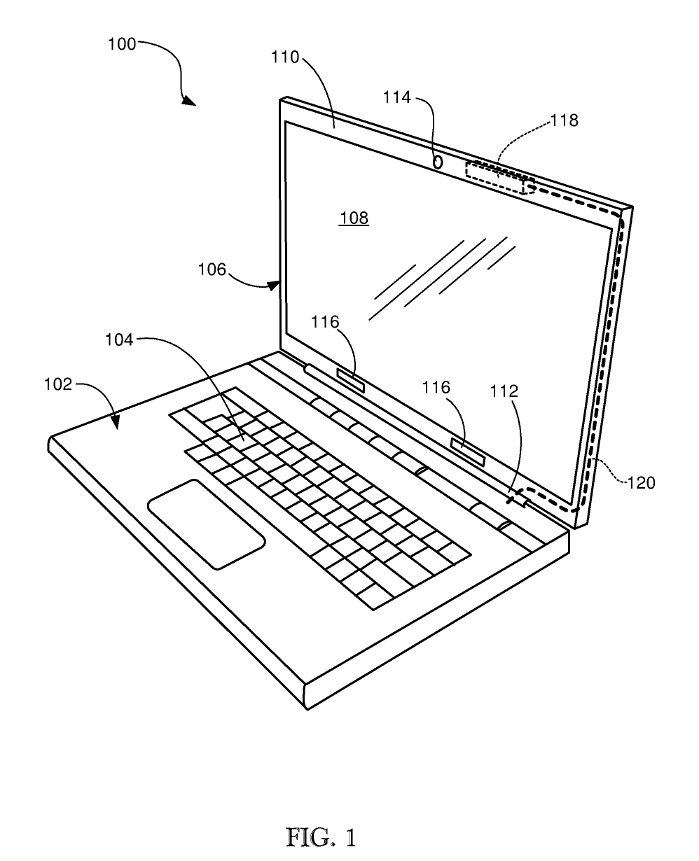

Advantageously, a notebook computer display enclosure with insert-molded antenna cables has been developed, which greatly simplifies the assembly and service process, and reduces the space needed within the enclosure for cable routing. Shown in FIG. 1 is a perspective view of an embodiment of a notebook computer 100, which includes a base section 102 having a keyboard 104 and related structure for data entry and control by a user, and a display section 106 having an LCD display screen 108. The display section comprises a housing or enclosure 110 that is hingedly connected to the base section 102 via an elongate hinge 112. In this embodiment the display section also includes a camera lens assembly 114 for use as a web camera, etc., and includes a pair of keyboard lights 116 located below the LCD display screen.

Located within the housing 110 of the display section 106 are an antenna unit 118 and its associated cable 120, shown in hidden lines in FIG. 1. It is to be appreciated that the term “cable” as used herein is intended to refer to any type of electrical conductor, including solid wires, twisted cables, etc. The cable extends from the base section 102 of the notebook computer, through the display hinge 112, into the display housing, around (or behind) the LCD display 108 and up to the antenna unit 118, located within the display enclosure near the top. This position for the antenna is desirable for good wireless reception. It is to be appreciated that this is only one of many antenna configurations, and that many different notebook computer antenna positions and configurations can be used.

The antenna cable 120 is shown passing through the hinge 112 in the embodiment of FIG. 1. This is a common configuration for notebook and laptop computers. In electronic devices with hinged parts, the hinges can include an aperture that is aligned with the axis of rotation of the hinges, and through which cables and the like can pass. This configuration prevents rotation of the hinged part from damaging these cables, and prevents the cables from restricting movement of the hinged portion. However it is to be appreciated that other mechanisms can be used for the routing of electrical conductors or other structure (e.g. fiber optic cables) through or around a hinge. For example, electrical conductors and the like can pass through a hinge, or they can pass nearby or around the hinge in a manner that will allow pivoting of the hinged portion without damaging the conductors or binding of the hinged portion. Accordingly, the term “hinge region” is used herein to refer to both the display hinge 112 and to the supporting structure surrounding the hinge. Structure that passes through the hinge region can pass through the hinge itself, or it can pass near the hinge in any arrangement that will allow free pivoting of the hinged portion without damaging the conductor.

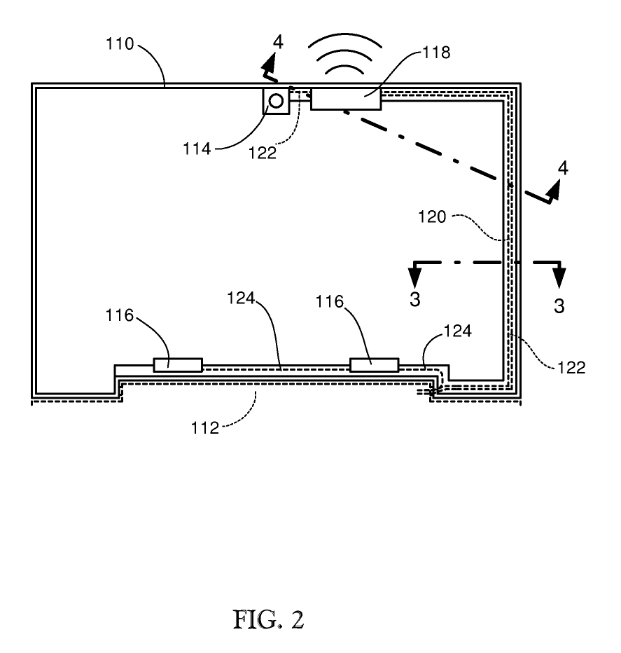

A more detailed front view of the display enclosure 110 of the notebook computer 100 of FIG. 1 is provided in FIG. 2. In this view the LCD display 108 and associated components (e.g. display bezel, mounting components, etc.) have been removed to show the antenna cable 120 and antenna unit 118. Also visible are the camera lens assembly 114 and its associated cable 122, and the keyboard lights 116 and their associated power cable 124. As is common with notebook computer devices, the display enclosure 110 can be injection molded of durable polymer material. Advantageously, a system has been developed wherein the antenna cable and other cables, etc. are insert-molded into the display enclosure. Thus, as shown in FIG. 2, the antenna cable 120 is encased within the polymer material of the display enclosure, and extends around the outer perimeter of the enclosure from the region of the hinge 112 to the location of the antenna unit 118.

The camera cable 122 is also encased within the material of the display enclosure 110, and follows largely the same path as the antenna cable to the camera assembly 114. Additionally, the power cable 124 for the keyboard lights 116 can also be encased within the material of the display enclosure, this cable extending from the hinge 112 to the light units in the bottom region of the display enclosure. The various cables shown in FIG. 2 are only exemplary of the types of cables and connectors that can be included in the display enclosure unit. A wide variety of cables, connectors and other structure can be insert molded within the display enclosure. Connection points and other devices can be provided as part of or added to the display housing to facilitate attachment of the antenna module 118, camera assembly 114, and other devices.

Insert molding the antenna cable and connector module, as well as other devices into the display housing can provide several desirable results. Insert molding is an injection molding process in which molten polymer material (thermoplastic) is injected into a mold and around one or more insert pieces that have been placed into the mold prior to molding. The result is a single injection molded piece with the insert(s) encapsulated by the plastic. Insert molding was initially developed as a way to encapsulate wires in electrical cords, or to place threaded inserts in molded parts, for example. Today insert molding is used extensively in the manufacture of electronic devices, consumer products, medical devices, and a host of other products. Inserts can include metal stampings, bushings, electromechanical parts, filtration materials, metal reinforcement and other discrete parts that are combined into a single unitary component through the injection of thermoplastic around the carefully placed parts.

There are relatively few design limitations or restrictions on material combinations in insert molding. For example, the inserts can be made of metal or another polymer material. Like injection molding in general, insert molding can be accomplished with a wide variety of materials, including polyethylene, polystyrene, polypropylene, polyvinyl chloride, thermoplastic elastomers, and many engineering plastics. The primary factors that govern the use of insert molding are generally not process related, but are determined by the strength and other desired properties of the molded product.

During the insert molding process the insert becomes mechanically bonded to the thermoplastic material through shrinkage of the polymer material and by the encapsulation of irregularities in the surface of the insert by the thermoplastic. It can be very desirable to have a strong mechanical bond between the insert and the surrounding polymer material, especially where the insert performs a mechanical function, such as a threaded insert. When insert molding dissimilar materials, the insert is frequently designed or treated to enhance mechanical bonding. For example, an insert can be provided with a sandblasted, flared, or knurled surface that bonds more securely to the thermoplastic material. Inserts can also become molecularly bonded to the injected thermoplastic material when the insert material is the same as or similar to the encapsulating thermoplastic (e.g. a polyurethane insert in a polyurethane part).

Molds for insert molding are generally designed in a similar fashion to molds for standard injection molding. However, there are some special considerations that can be involved. Those of skill in the art will be aware that some molding machine designs are better suited for insert molding than others, and can offer much greater flexibility and productivity. For example, insert molding typically involves higher injection pressures (e.g. up to about 1000 psi) in order to cause the thermoplastic material to flow around all surfaces of the insert, and the molds are designed to withstand these higher pressures. Insert molds also include support structures to hold the insert(s) in the proper position during molding. For insert-molded electrical parts, it is also desirable to ensure that the intended voltage and current for that part are within a range that will not damage the surrounding injection-molded material.

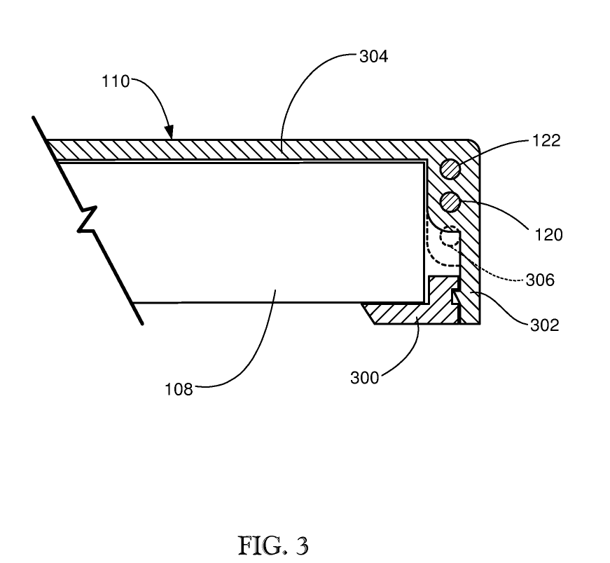

Shown in FIG. 3 is a cross-sectional view of an edge of the display enclosure 110, showing a portion of the LCD display screen 108 and a display bezel 126 that surrounds the display screen when the display unit 106 is fully assembled. In this view the insert-molded antenna cable 120 and camera cable 122 can be seen encased within an enlarged region of polymer material at the junction of the sidewall 302 and back wall 304 of the display enclosure. The cables are molded into the material of the display housing, providing a solid, clean design. In this configuration there is no need to route loose cables through the housing during assembly, and less likelihood that cables can be pinched or otherwise compromised during assembly or use of the device. Where space permits, an additional insert-molded cable 306 or other device (shown in dashed lines) can also be provided for any other desired purpose.

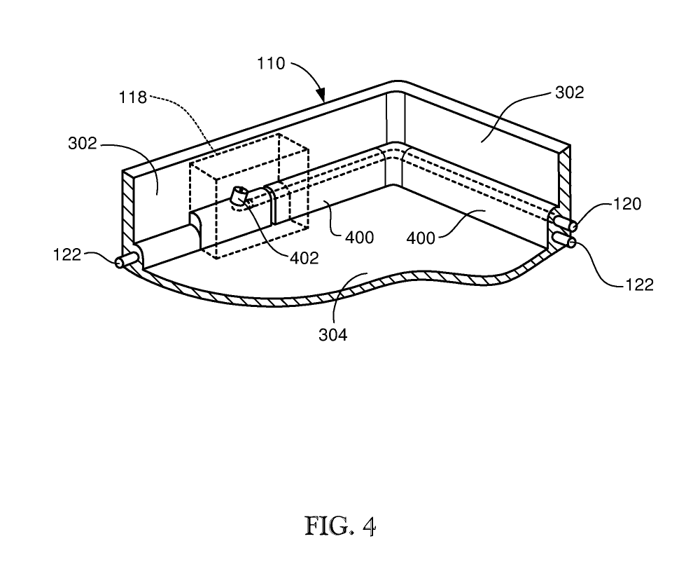

Provided in FIG. 4 is a partially broken-out, perspective view of a portion of the display enclosure 110 of FIG. 2. As noted above, the enclosure includes sidewalls 302 and a backwall 304. The antenna cable 120 and camera cable 122 are insert molded into a bulge 400 that is molded into the junction between the backwall and the sidewalls. An antenna connector module 402 can also be insert-molded into the housing 110 at the terminal end of the antenna cable. This connector module can be connected to the antenna cable 120 prior to molding, and inserted into the mold as a subassembly. The antenna cable 120 can be a coaxial cable, and the connector 402 can be a miniature coaxial connector, for example. The connector module is designed to connect to the antenna module 118 (shown in dashed lines in FIG. 4), which can be attached to the inside of the housing 110 during assembly of the notebook computer attached to the end of the antenna cable in a sub-assembly prior to insertion of the cable assembly into the mold for the display enclosure 110. The connector 402 can partially extend from the polymer material of the display enclosure as shown, providing a location for connection of a corresponding connector of the antenna module 118.

In the embodiment shown herein, the camera cable 122 extends beyond the terminal end of the antenna cable 120, given the relative locations of the camera assembly (114 in FIG. 2) and antenna unit 118. While the cables (124 in FIG. 2) for the keyboard lights (116 in FIG. 2) are not shown in the views of FIGS. 3 and 4, their routing and encasement in the polymer material can be provided in a similar manner.

In addition to the antenna cable and other cables shown, additional cables and other structure can also be insert-molded into the display housing 110. These additional parts can be inserted in the mold in the same manner as the antenna cable, and positioned to allow the polymer material to surround and separate these parts. Advantageously, the electrical insulating properties of injection-moldable polymer materials are very useful in this approach, allowing bare metal conductors to be placed into a mold and surrounded with electrically insulating material that forms the injection-molded structure.

With the antenna cable and other cables insert-molded into the display housing, this configuration provides simplified and faster final assembly, and simplifies service events. For example, where wires and cables are insert-molded into the display housing, rather than being separate parts that must be routed through the housing, less labor is required for assembly, and fewer assembly mistakes are likely. Also, because the wires are encased, there is less likelihood of damage during assembly, use and servicing of the device. The result is a simplified and robust display housing that places cables and devices in desirable positions and also simplifies manufacture and assembly.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A display housing, comprising:
an injection-molded enclosure, configured for hinged attachment to a base of a portable computer at a hinge region; and
a conductor, insert-molded into the enclosure, extending from the hinge region.

2. A display housing in accordance with claim 1, wherein the conductor comprises an antenna cable, extending to an antenna unit attachment point within the enclosure.

3. A display housing in accordance with claim 1, further comprising multiple insert-molded devices, encased within the enclosure.

4. A display housing in accordance with claim 3, wherein the insert-molded devices are selected from the group consisting of an antenna cable, a camera cable, a power cable for a light, and connecting devices.

5. A display housing in accordance with claim 1, wherein the conductor is encased within an enlarged region of polymer material around a perimeter of the enclosure and integral with a sidewall of the enclosure.

6. A computer, comprising:
a base portion;
a display portion, attached to the base portion at a hinge region, comprising an injection-molded enclosure; and
a conductor, insert-molded into the enclosure, extending from the hinge region.

7. A computer in accordance with claim 6, further comprising an antenna unit, disposed at an upper region of the display portion, the conductor comprising an antenna cable extending from the hinge region to the antenna unit.

8. A computer in accordance with claim 7, wherein the display portion includes an LCD display, and the insert-molded antenna cable extends around a side of the display, from a location below the display to a location above the display.

9. A computer in accordance with claim 6, wherein the conductor is encased within an enlarged region of polymer material integral with a sidewall of the enclosure.

10. A computer in accordance with claim 6, further comprising:
at least one device selected from the group consisting of an antenna, a camera assembly and a keyboard light, attached to the enclosure of the display portion; and
wherein the conductor extends to the at least one device from the hinge region.

11. A computer in accordance with claim 6, further comprising multiple insert-molded devices, encased within the enclosure, the insert-molded devices being selected from the group consisting of an antenna cable, a camera cable, a power cable for a light, and connecting devices.

12. A method for producing a display housing for a portable computer, comprising the steps of:
providing an injection mold having a desired shape for the housing;
placing a conductor into the mold; and
injecting polymer material into the mold to encase the conducting device therein.

13. A method in accordance with claim 12, wherein the conductor comprises an antenna cable.

14. A method in accordance with claim 13, further comprising the step of placing an antenna connector unit at a terminal end of the antenna cable, such that the antenna connector unit becomes encased within the polymer material with the antenna cable.

15. A method in accordance with claim 12, further comprising the step of placing within the mold, before injecting polymer material thereinto, at least one device selected from the group consisting of a camera cable, a power cable for a light, and connecting devices.
